(19) United States
(12) Patent Application Publication
(10) Pub. No.: US 2016/0333277 A1
(43) Pub. Date: Nov. 17, 2016

(54) METHOD FOR REMOVING SULFUR COMPOUNDS FROM HYDROCARBON STREAMS

(71) Applicant: BASF SE, Ludwigshafen (DE)

(72) Inventors: Steffen WAGLÖHNER, Bad Schönborn (DE); Michael BENDER, Ludwigshafen (DE); Andreas KUSCHEL, Heidelberg (DE); Wolfgang RÜTTINGER, Mannheim (DE); Philipp BRÜGGEMANN, Mannheim (DE)

(73) Assignee: BASF SE, Ludwigshafen (DE)

(21) Appl. No.: 15/110,128

(22) PCT Filed: Jan. 8, 2015
(86) PCT No.: PCT/EP2015/050189

§ 371 Date: Jul. 7, 2016

(30) Foreign Application Priority Data
Jan. 10, 2014 (EP) 14150812.7

(51) Int. Cl. C10G 25/00; C10G 25/12; C10G 25/09; B01D 53/04; C10L 3/12

(52) U.S. Cl. CPC C10G 25/003; B01D 53/04; C10L 3/12; C10G 25/09; C10G 25/12; B01D 2253/1128; B01D 2256/24; B01D 2257/306; B01D 2257/308; C10L 2290/542; C10L 2290/12; C10G 2300/202

(57) ABSTRACT

A process for removing sulfur compounds selected from mercaptans (R—SH), organic sulfides (R—S—R′), organic disulfides (R—S—S—R′) and carbonyl sulfide (COS) from a hydrocarbonaceous stream comprises an absorption step of contacting the hydrocarbonaceous stream comprising one or more sulfur compounds with an absorbent comprising a first transition metal sulfide to bind at least some of the sulfur present in the sulfur compound or compounds in the transition metal sulfide as additional sulfur to form a second transition metal sulfide.

The invention relates to a process for removing sulfur compounds from hydrocarbonaceous streams using an absorbent comprising a transition metal sulfide.

Removing sulfur compounds from hydrocarbonaceous streams may be necessary for a number of reasons. If the hydrocarbonaceous stream is to be burned as fuel, removing sulfur is necessary in order to prevent the release of environmentally harmful flue gases. Even when the hydrocarbonaceous stream is to be subjected to further processing, removing sulfur is often necessary in order, for example, to prevent poisoning of sulfur-sensitive catalysts or to protect metallic components from corrosion.

A number of processes are known in which solid sorbents are used in order to remove sulfur from hydrocarbonaceous fluid streams. Desulfurization by means of adsorption/absorption is based on the ability of the sorbent to bind sulfur compounds selectively. It is possible to discriminate between two different groups of desulfurization processes depending on the form in which the sulfur is being bound. In adsorptive desulfurization, binding is effected in a purely physical manner. The sulfur compound as such adsorbs onto the sorbent. By contrast, in reactive adsorption desulfurization the binding of the sulfur is effected in principle via chemical interaction between the sulfur compound and the sorbent. Sulfur generally binds to the sorbent as a sulfide. The desulfurized i.e. sulfur-free compound is released.

The effectiveness with which the hydrocarbonaceous streams are desulfurized is critically dependent on the properties of the sorbent and the nature of the sulfur compounds.

Sorbents often used for desulfurization comprise a transition metal oxide component, for example ZnO, and a promoter metal component, for example Ni. The removal of the sulfur is effected by the transition metal oxide at the surface of the sorbent (e.g. ZnO) reacting with the sulfur compound causing the sulfur to bind to the sorbent in the form of a transition metal sulfide (e.g. ZnS).

The resulting sulfur-laden sorbent can be regenerated by contacting with an oxygen-containing regeneration stream. This converts the transition metal sulfide (e.g. ZnS) at the surface of the sorbent back into the transition metal oxide (e.g. ZnO). Following regeneration, the oxidized sorbent still requires treatment with a hydrogen-containing reduction stream in order to reduce the promoter metal component and convert the sorbent into its original state. Only after the reduction is the sorbent fit for re-use.

US 2009/0193969 A1 discloses, for example, a desulfurization process in which (a) a gas stream comprising sulfur compounds is contacted with a sorbent based on zinc and a promoter metal in a sorption zone and (b) the sulfur-laden sorbent is regenerated in a regeneration zone by initially drying it at elevated temperature under inert gas and subsequently carrying out the regeneration using a regeneration gas stream comprising oxygen. This process can be used to remove sulfur compounds such as, for example, hydrogen sulfide (H₂S), carbonyl sulfide (COS) and carbon disulfide (CS₂).

In addition, processes are also known in which the use of zinc is not mandatory. For example, US 2008/0190852 A1 describes a process for removing sulfur compounds, such as hydrogen sulfide, carbonyl sulfide, mercaptans (R—SH) and organic disulfides (R—S—S—R′), from hydrocarbonaceous gas streams using a sorbent based on iron carbonate (FeCO₃). The sorbent can be regenerated using a regeneration stream comprising oxygen and water.

Although good results are achieved using the desulfurization processes described, there is still room for improvement.

One disadvantage of existing processes is, for example, that often the regeneration of the sorbents used necessitates more than one step and is therefore inconvenient and costly. Another disadvantage is that during regeneration the sulfur bound to the sorbent is generally oxidized to form gaseous sulfur oxides or reduced to form hydrogen sulfide. These gaseous sulfur compounds generally need to undergo further reaction, for example in a Claus process to give elemental sulfur.

It is therefore an object of the present invention to provide an improved process for removing sulfur compounds from hydrocarbonaceous streams. In particular, the process should be economically sensible and should not have the above described disadvantages of the prior art processes, i.e. the regeneration of the absorbent should be relatively simple to carry out and the formation of sulfur oxides and hydrogen sulfide should ideally be avoided.

It is known that certain transition metal sulfides, such as iron(II) sulfide FeS, can under suitable reaction conditions react with hydrogen sulfide (H₂S), in which case elemental hydrogen is released and the sulfur from the hydrogen sulfide binds to the transition metal.

DE 3224870 A1 discloses a process for obtaining hydrogen and elemental sulfur from hydrogen sulfide (H₂S), wherein initially a particulate absorbent comprising transition metal sulfide is contacted with hydrogen sulfide gas in a fluidized-bed reactor at operating temperatures of from 350° C. to 550° C. to simultaneously load the absorbent particles with sulfur and form gaseous hydrogen, and subsequently the laden absorbent particles are regenerated at temperatures of from 600° C. to 950° C. to release elemental sulfur. Similarly, U.S. Pat. No. 2,979,384 discloses a process for producing hydrogen and elemental sulfur from hydrogen sulfide using transition metal sulfides such as iron(II) sulfide.

It has now been found that under suitable reaction conditions certain transition metal sulfides can react with sulfur compounds such as mercaptans (R—SH), organic sulfides (R—S—R′), organic disulfides (R—S—S—R) and carbonyl sulfide (COS). And this is even when the sulfur compounds are present in a hydrocarbonaceous mixture in but small amounts or traces. It was further found that at least some of the sulfur present in the sulfur compound or compounds becomes bound in the transition metal sulfide as additional sulfur.

On the basis of this surprising finding, the object of the present invention is achieved by a process for removing sulfur compounds selected from mercaptans (R—SH), organic sulfides (R—S—R′), organic disulfides (R—S—S—R′) and carbonyl sulfide (COS) from a hydrocarbonaceous stream, which process comprises an absorption step of contacting the hydrocarbonaceous stream comprising one or more sulfur compounds with an absorbent comprising a first transition metal sulfide to bind at least some of the sulfur present in the sulfur compound or compounds in the transition metal sulfide as additional sulfur to form a second transition metal sulfide.

In the absorption step the sulfur present in the sulfur compounds selectively binds to the absorbent comprising a first transition metal sulfide, without noticeable co-absorption of other components, particularly of unsaturated or aromatic hydrocarbons, of the hydrocarbonaceous stream.

For the purposes of the present invention, no distinction is made between adsorption and absorption. The terms “absorption”, “absorbent” and “absorption step” are used throughout, regardless of the physical or chemical processes ultimately responsible for the accumulation of sulfur and/or of sulfur compounds. The term “absorption” is used for the purposes of the present invention for any type of accumulation of gaseous or liquid compounds on or in proximity to the surface of a solid. The term thus comprises physical adsorption (physisorption), chemical adsorption (chemisorption) and absorption in the narrower sense. This applies analogously with regard to the terms “absorbent” and “absorption step”.

The first transition metal sulfide is preferably selected from sulfides of chromium, molybdenum, tungsten, manganese, iron, cobalt, nickel and copper and also mixtures thereof. It is particularly preferable for the first transition metal sulfide to be selected from sulfides of iron, cobalt, nickel, copper and also mixtures of these sulfides, iron sulfide being very particularly preferred.

For the purposes of the present invention, the term “transition metal” is to be understood as meaning a metal selected from one of the groups IIIB, IVB, VB, VIB, VIIB VIIIB, IB and IIB of the periodic table of the elements.

The sulfur in the first transition metal sulfide in principle has a mean oxidation number between −2 and −1. The mean oxidation number of the sulfur is preferably between −2 and −1.2, more preferably between −2 and −1.4, yet more preferably between −2 and −1.6.

The first transition metal sulfide in principle has a sulfur to transition metal amount of substance ratio (n_{S}/n_{M}) of between 0.5 and 2.0 (0.5<n_{S}/n_{M}<2.0). The amount of substance ratio in the first transition metal sulfide depends on the choice of transition metal and on its oxidation state.

The amount of substance ratio is preferably between 0.5 and 1.6 (0.5<n_{S}/n_{M}<1.6) and more preferably between 0.8 and 1.4 (0.8<n_{S}/n_{M}<1.4).

In one embodiment of the present invention, the first transition metal sulfide comprises iron(II) sulfide having the stoichiometric formula FeS_{0.5 to 2.0}, preferably FeS_{0.5 to 1.6} and more preferably FeS_{0.8 to 1.4}. The first transition metal sulfide most preferably comprises iron(II) sulfide having the stoichiometric formula FeS.

In one variant of the process according to the invention, the absorbent used consists of one or more first transition metal sulfides. Particles consisting of a first transition metal sulfide and having a mean particle diameter of between 1 μm and 10 mm are particularly useful as absorbent for this process variant. The mean particle diameter of the particles is preferably between 10 μm and 1000 μm, more preferably between 50 μm and 500 μm. Such particles of a first transition metal sulfide are commercially available or can at least be prepared from appropriate commercially available transition metal sulfides of other forms using simple processes known to those skilled in the art. Shaped bodies such as, for example, compacts consisting of a first transition metal sulfide are also useful for this variant.

The absorbent brought contacted with a hydrocarbonaceous stream in the absorption step may in a further variant of the process according to the invention comprise further components in addition to the first transition metal sulfide or sulfides. Further components may, for example, include support materials for the first transition metal sulfide. Useful support materials are, for example, composed of aluminum oxide, silicon oxide, aluminosilicate, magnesium silicate or carbon. In a preferred embodiment, the absorbent is a shaped body coated with a first transition metal sulfide.

Further components may also include auxiliary agents such as binders, compounding agents or other additives, preferably added when shaped bodies are prepared. The type and amount added of an auxiliary agent depend on the method of preparation of the shaped body.

The absorbents comprising a first transition metal sulfide that are used in the process according to the invention can be prepared and/or made into a particular shape according to suitable known processes for preparation. Examples of such processes comprise impregnation and spray impregnation, and also strand pressing, compounding, pelletizing, tabletting, extruding, co-extruding and spray drying. The processes as such and also the auxiliary agents to be used therein are known to those skilled in the art.

The process according to the invention for removing sulfur compounds can in principle be used to desulfurize any desired gaseous or liquid hydrocarbonaceous streams. Suitable hydrocarbonaceous streams comprise, for example, not only natural gas and NGL (Natural Gas Liquids) but also various comparatively low-boiling products of crude oil rectification such as LPG (Liquefied Petroleum Gas), light naphtha, heavy naphtha and kerosene. Accordingly, the hydrocarbonaceous stream generally comprises hydrocarbons selected from linear or branched C₁-C₂₀ alkanes, C₂-C₂₀ alkenes, C₂-C₂₀ alkynes; substituted or unsubstituted C₃-C₂₀ cycloalkenes, C₃-C₂₀ cycloalkenes, C₈-C₂₀-cycloalkynes; substituted or unsubstituted, mono- or polycyclic C₆-C₂₀ aromatics and mixtures thereof.

The process according to the invention is preferably used for removing sulfur compounds selected from mercaptans (R—SH), organic sulfides (R—S—R′), organic disulfides (R—S—S—R) and carbonyl sulfide (COS) from the hydrocarbonaceous streams natural gas, NGL, LPG, or light naphtha. It is particularly preferable for the hydrocarbonaceous stream to be selected from NGL and LPG.

The most important source of LPG is crude oil. In the rectification of crude oil in refineries, LPG is normally obtained as top product. The hydrocarbons comprised in LPG, and also the ratio of these to one another, depend on the crude oil source and the process parameters of the rectification. Unlike LPG, NGL is obtained from natural gas.

In general, both LPG and NGL are essentially composed of linear or branched cyclic or acyclic C₁-C₆ alkanes, C₂-C₆ alkenes and C₂-C₆ alkynes, of which C₃-C₄ alkanes are generally the main components. NGL and LPG generally comprise at least 70 vol % of C₁-C₆ alkanes, preferably at least 80 vol % of C₁-C₆ alkanes, more preferably at least 80 vol % of C₂-C₅ alkanes and most preferably 90 vol % of C₂-C₅ alkanes.

In a preferred embodiment of the present invention, the hydrocarbonaceous stream comprises at least 80 vol % of C₁-C₆ alkanes, more preferably at least 80 vol % of C₂-C₅ alkanes and most preferably 90 vol % of C₂-C₅ alkanes.

The term “C₁-C₆ alkanes” for the purposes of the present invention means linear or branched cyclic or acyclic alkanes selected from the group consisting of methane, ethane, n-propane, n-butane, n-pentane, n-hexane, 2-methylpropane, 2-methylbutane, 2,2-dimethylpropane, 2-methylpentane, 3-methylpentane, 2,2-dimethylbutane, 2,3-dimethylbutane, cyclopropane, cyclobutane, methylcyclopropane, cyclopentane, methylcyclobutane, 1,1-dimethylcyclopropane, 1,2-dimethylcyclopropane, ethylcyclopropane, cyclohexane, methylpentane, 1,1-dimethyl-butane, 1,2-dimethylbutane, 1,3-dimethylbutane, ethylcyclobutane, 1,1,2-trimethylcyclopropane, 1,2,3-trimethylcyclopropane, 1-ethyl-1-methylcyclopropane, 1-ethyl-2-methylcyclopropane, iso-propylcyclopropane and mixtures thereof.

Accordingly, the term “C₂-C₅ alkanes” for the purposes of the present invention means linear or branched cyclic or acyclic alkanes selected from the group consisting of ethane, n-propane, n-butane, n-pentane, 2-methylpropane, 2-methylbutane, 2,2-dimethylpropane, cyclopropane, cyclobutane, methylcyclopropane, cyclopentane, methylcyclobutane, 1,1-dimethylcyclopropane, 1,2-dimethylcyclopropane, ethylcyclopropane and mixtures thereof.

The term “C₂-06 alkenes” for the purposes of the present invention means linear or branched cyclic or acyclic alkenes selected from the group consisting of ethene, propene, 1-butene, 2-butene, 1-pentene, 2-pentene, 1-hexene, 2-hexene, 3-hexene, 2-methylpropene, 2-methylbut-1-ene, 3-methylbut-1-ene, 2-methylbut-2-ene, 2-ethylbut-1-ene, 2-methylpent-1-ene, 3-methylpent-1-ene, 4-methylpent-1-ene, 2-methylpent-2-ene, 3-methylpent-2-ene, 4-methyl-pent-2-ene, cyclobutene, cyclopentene, cyclohexene, 1-methylcyclobutene, 3-methylcyclobutene, 1-methylcyclopentene, 2-methylcyclopentene, 3-methylcyclopentene, 1,2-dimethylcyclobutene, 1,3-dimethylcyclobutene, 1,4-dimethylcyclobutene, 3,3-dimethylcyclobutene and mixtures thereof.

The term “C₂-C₆ alkynes” for the purposes of the present invention means linear or branched acyclic alkynes selected from the group consisting of ethyne, propyne, 1-butyne, 2-butyne, 1-pentyne, 2-pentyne, 1-hexyne, 2-hexyne, 3-hexyne, 3-methylbut-1-yne, 3,3-dimethylbut-1-yne, 4-methylpent-1-yne and mixtures thereof.

In addition to the hydrocarbons mentioned, the hydrocarbonaceous stream comprises one or more sulfur compounds that can be completely or partially removed using the process according to the invention. For example, the hydrocarbonaceous stream may comprise sulfur compounds such as mercaptans (R—SH), sulfides (R—S—R′), organic disulfides (R—S—S—R′), hydrogen sulfide (H₂S), carbonyl sulfide (COS), carbon disulfide (CS₂) and thiophenes.

In addition to hydrocarbons and sulfur compounds, the hydrocarbonaceous stream may comprise further typically comprising compounds such as amines, alcohols or ethers, which generally do not negatively affect the process according to the invention.

Gas components that do negatively affect the process for removing sulfur compounds should be present in very low quantities in the hydrocarbonaceous streams to be desulfurized. These include oxidants such as, for example, molecular oxygen, halogens and oxides of nitrogen, since these may partially oxidize and thus render ineffective the first and/or as the case may be the second transition metal sulfide. In addition, there is also a risk that sulfur oxides which remain in the hydrocarbonaceous gas stream and thereby lower the degree of desulfurization are formed. It is therefore preferable for the hydrocarbonaceous stream to comprise not more than a total of 1.0 vol % and more preferably not more than a total of 0.5 vol % of oxidants such as for example molecular oxygen.

Unless expressly indicated otherwise, the values stated in vol % are based in each case on the total volume of the hydrocarbonaceous stream.

The process according to the invention is particularly useful for removing sulfur compounds, selected mercaptans (R—SH), organic sulfides (R—S—R′), organic disulfides (R—S—S—R′) and carbonyl sulfide (COS) from hydrocarbonaceous streams generally comprising at least 0.001 vol %, preferably at least 0.01 vol % of sulfur compounds and generally comprising no more than 5.0 vol %, preferably no more than 2.0 vol % and more preferably no more than 1.0 vol % of sulfur compounds.

The mercaptans (R—SH) occurring in the hydrocarbonaceous streams are generally C₁-C₁₀ mercaptans. The hydrocarbonaceous stream preferably comprises C₁-C₆ mercaptans. The term “C₁-C₆ mercaptans” in particular comprises one or more mercaptans selected from the group consisting of methyl mercaptan (Me-SH), ethyl mercaptan (Et-SH), vinyl mercaptan, n-propyl mercaptan, isopropyl mercaptan, allyl mercaptan, n-butyl mercaptan, isobutyl mercaptan, sec-butyl mercaptan, tert-butyl mercaptan, n-pentyl mercaptan, 3-methylbutyl mercaptan, 2-methylbutyl mercaptan, 1-methylbutyl mercaptan, 1-ethylpropyl mercaptan, n-hexyl mercaptan, 4-methylpentyl mercaptan, 3-methylpentyl mercaptan, 2-methylpentyl mercaptan, 1-methylpentyl mercaptan, 2-ethylbutyl mercaptan, 1-ethylbutyl mercaptan, 1,1-dimethylbutyl mercaptan, 1,2-dimethylbutyl mercaptan, 1,3-dimethylbutyl mercaptan, 2,2-dimethylbutyl mercaptan, 2,3-dimethylbutyl mercaptan, 3,3-dimethylbutyl mercaptan, 1,1,2-trimethylpropyl mercaptan, 1,2,2-trimethylpropyl mercaptan, 1-ethyl-1-methylpropyl mercaptan and 1-ethyl-2-methylpropyl mercaptan.

The content of mercaptans in the hydrocarbonaceous stream prior to carrying out the absorption step is preferably 0.001 to 5 vol %, more preferably 0.01 to 2 vol % and most preferably 0.01 to 1 vol %.

The organic sulfides (R—S—R′) occurring in the hydrocarbonaceous streams are generally sulfides having two identical or different, linear or branched, saturated or unsaturated hydrocarbon radicals of 1 to 10 carbon atoms (bis(C₁-C₁₀) sulfides). The hydrocarbonaceous stream preferably comprises sulfides having two identical or different linear or branched, saturated or unsaturated hydrocarbon radicals of 1 to 6 carbon atoms (bis(C₁-C₆) sulfides). The term “(bis(C₁-C₆) sulfides)” in particular comprises one or more sulfides selected from the group consisting of dimethyl sulfide (Me-S-Me), ethyl methyl sulfide (Et-S-Me), methyl n-propyl sulfide, methyl isopropyl sulfide, n-butyl methyl sulfide, isobutyl methyl sulfide, sec-butyl methyl sulfide, tert-butyl methyl sulfide, methyl n-pentyl sulfide, methyl 3-methylbutyl sulfide, methyl 2-methylbutyl sulfide, methyl 1-methylbutyl sulfide, methyl 1-ethylpropyl sulfide, n-hexyl methyl sulfide, methyl 4-methylpentyl sulfide, methyl 3-methylpentyl sulfide, methyl 2-methylpentyl sulfide, methyl 1-methylpentyl sulfide, 2-ethylbutyl methyl sulfide, 1-ethylbutyl methyl sulfide, methyl 1,1-dimethylbutyl sulfide, methyl 1,2-dimethylbutyl sulfide, methyl 1,3-dimethylbutyl sulfide, methyl 2,2-dimethylbutyl sulfide, methyl 2,3-dimethylbutyl sulfide, methyl 3,3-dimethyl-butyl sulfide, methyl 1,1,2-trimethylpropyl sulfide, methyl 1,2,2-trimethylpropyl sulfide, 1-ethyl-1-methylpropyl methyl sulfide, 1-ethyl-2-methylpropyl methyl sulfide, diethyl sulfide, ethyl n-propyl sulfide, ethyl isopropyl sulfide, n-butyl ethyl sulfide, isobutyl ethyl sulfide, sec-butyl ethyl sulfide, tert-butyl ethyl sulfide, ethyl n-pentyl sulfide, ethyl 3-methylbutyl sulfide, ethyl 2-methylbutyl sulfide, ethyl 1-methylbutyl sulfide, ethyl 1-ethylpropyl sulfide, ethyl n-hexyl sulfide, ethyl 4-methylpentyl sulfide, ethyl 3-methylpentyl sulfide, ethyl 2-methylpentyl sulfide, ethyl 1-methyl-pentyl sulfide, ethyl 2-ethylbutyl sulfide, ethyl 1-ethylbutyl sulfide, ethyl 1,1-dimethylbutyl sulfide, ethyl 1,2-dimethylbutyl sulfide, ethyl 1,3-dimethylbutyl sulfide, ethyl 2,2-dimethylbutyl sulfide, ethyl 2,3-dimethylbutyl sulfide, ethyl 3,3-dimethylbutyl sulfide, ethyl 1,1,2-trimethylpropyl sulfide, ethyl 1,2,2-trimethylpropyl sulfide, methyl 1-ethyl-1-methylpropyl sulfide, ethyl 1-ethyl-2-methyl-propyl sulfide, di-n-propyl sulfide, isopropyl n-propyl sulfide and diisopropyl sulfide. The content of organic sulfides in the hydrocarbonaceous stream prior to carrying out the absorption step is generally 0.001 to 2.0 vol %, The content of sulfides is preferably 0.01 to 1.0 vol %, more preferably 0.01 to 0.5 vol %.

The organic disulfides (R—S—S—R′) occurring in the hydrocarbonaceous streams are generally disulfides having two identical or different, linear or branched, saturated or unsaturated hydrocarbon radicals of 1 to 10 carbon atoms. The hydrocarbonaceous stream preferably comprises disulfides comprising two identical or different, linear or branched, saturated or unsaturated hydrocarbon radicals of 1 to 6 carbon atoms. Examples of such disulfides (R—S—S—R′) include dimethyl disulfide (Me-S—S-Me), ethyl methyl disulfide (Et-S—S-Me), methyl n-propyl disulfide, methyl isopropyl disulfide, n-butyl methyl disulfide, isobutyl methyl disulfide, sec-butyl methyl disulfide, tert-butyl methyl disulfide, methyl n-pentyl disulfide, methyl 3-methylbutyl disulfide, methyl 2-methylbutyl disulfide, methyl 1-methylbutyl disulfide, methyl 1-ethylpropyl disulfide, n-hexyl methyl disulfide, methyl 4-methylpentyl disulfide, methyl 3-methylpentyl disulfide, methyl 2-methylpentyl disulfide, methyl 1-methylpentyl disulfide, 2-ethylbutyl methyl disulfide, 1-ethylbutyl methyl disulfide, methyl 1,1-dimethylbutyl disulfide, methyl 1,2-dimethyl-butyl disulfide, methyl 1,3-dimethylbutyl disulfide, methyl 2,2-dimethylbutyl disulfide, methyl 2,3-dimethylbutyl disulfide, methyl 3,3-dimethylbutyl disulfide, methyl 1,1,2-trimethylpropyl disulfide, methyl 1,2,2-trimethylpropyl disulfide, 1-ethyl-1-methylpropyl methyl disulfide, 1-ethyl-2-methyl-propyl methyl disulfide, diethyl disulfide, ethyl n-propyl disulfide, ethyl isopropyl disulfide, n-butyl ethyl disulfide, isobutyl ethyl disulfide, sec-butyl ethyl disulfide, tert-butyl ethyl disulfide, ethyl n-pentyl disulfide, ethyl 3-methylbutyl disulfide, ethyl 2-methylbutyl disulfide, ethyl 1-methylbutyl disulfide, ethyl 1-ethylpropyl disulfide, ethyl n-hexyl disulfide, ethyl 4-methylpentyl disulfide, ethyl 3-methylpentyl disulfide, ethyl 2-methylpentyl disulfide, ethyl 1-methylpentyl disulfide, ethyl 2-ethylbutyl disulfide, ethyl 1-ethylbutyl disulfide, ethyl 1,1-dimethylbutyl disulfide, ethyl 1,2-dimethylbutyl disulfide, ethyl 1,3-dimethylbutyl disulfide, ethyl 2,2-dimethylbutyl disulfide, ethyl 2,3-dimethylbutyl disulfide, ethyl 3,3-dimethylbutyl disulfide, ethyl 1,1,2-trimethylpropyl disulfide, ethyl 1,2,2-trimethylpropyl disulfide, methyl 1-ethyl-1-methylpropyl disulfide, ethyl 1-ethyl-2-methylpropyl disulfide, di-n-propyl disulfide, isopropyl n-propyl disulfide and diisopropyl disulfide.

The content of organic disulfides (R—S—S—R′) in the hydrocarbonaceous stream prior to carrying out the absorption step is generally 0.001 to 1.0 vol %.

The content of carbonyl sulfide (COS) in the hydrocarbonaceous stream prior to carrying out the absorption step is generally 0.001 to 1.0 vol %.

In the process according to the invention the hydrocarbonaceous stream to be freed of sulfur compounds is contacted with the absorbent comprising a first transition metal sulfide, in one or more reaction vessel(s). There are no particular restrictions with regard to the choice of reaction vessel. In particular, the process can be carried out in batch mode or in continuous mode. The reaction vessel used in each case can be configured such that it has at least two different reaction zones which, for example, differ in temperature and/or pressure. When the process is carried out in two or more reaction vessels, these may consist of the same reactor type or of different reactor types. The reaction vessel used in the process according to the invention is preferably a tubular reactor or a tube bundle reactor.

In a preferred embodiment, the absorbent comprising a first transition metal sulfide is present in the reaction vessel or vessels in the form of a fixed bed. However, the absorbent can also be present in a fluidized bed.

The fixed bed may consist exclusively of the absorbent comprising a first transition metal sulfide or may comprise one or more further components in addition to the absorbent. In a preferred embodiment of the present invention, the fixed bed consists exclusively of the absorbent comprising a first transition metal sulfide. Shaped bodies coated with first transition metal sulfide and preferably shaped bodies composed of ceramic are particularly useful for this purpose. In another preferred embodiment, the fixed bed comprises one or more further components in addition to the absorbent. These further components can be added to influence certain process parameters in a targeted manner or to suppress aging phenomena of the absorbent. Further components that may be comprised in the fixed bed include, for example, random packings of different shapes and sizes. Random packings may, for example, be spherical, ring-shaped, cylindrical or saddle-shaped. The random packings can serve to control heat dissipation, but also to prevent agglomeration of the transition metal sulfide particles.

In another embodiment of the present invention, the first and the second transition metal sulfide are present in a fluidized bed. Suitable absorbents for use in a fluidized bed include, in particular, particles consisting of first transition metal sulfide and having a mean particle diameter of between 10 μm and 1000 μm, more preferably between 50 μm and 500 μm.

The temperature during the absorption step of the process according to the invention can generally be varied over a wide range. The hydrocarbonaceous stream is generally contacted with the first transition metal sulfide at a temperature of from 200 to 600° C., preferably from 200 to 400° C., more preferably from 250 to 400° C. and most preferably from 300 to 400° C.

The prevailing pressure in the absorption step is likewise variable over a wide range. The hydrocarbonaceous stream is typically contacted with the first transition metal sulfide at a pressure of from 10 to 150 bar. The pressure is preferably from 20 to 100 bar, more preferably from 30 to 70 bar.

The contact times may vary within wide limits. The contact times are generally in the range from 0.5 to 120 s, preferably 1 to 60 s, more preferably 1 to 10 s.

Using the process according to the invention, generally between 50 and 100 wt % of the sulfur compounds selected from mercaptans (R—SH), organic sulfides (R—S—R′), (R—S—S—R′) and carbonyl sulfide (COS) can be removed from a hydrocarbonaceous stream, based on the total weight of these sulfur compounds. Depending on the proportion of sulfur compounds in the hydrocarbonaceous stream and on the selected contact time, the degree of desulfurization may vary. It is preferable for degrees of desulfurization of between 60 and 100 wt %, preferably between 80 and 100 wt % and more preferably between 90 and 100 wt % to be achievable.

The desulfurization is brought about by at least some of the sulfur compounds present in the stream undergoing a chemical reaction with the first transition metal sulfide or sulfides of the absorbent during the contacting of the absorbent with the hydrocarbonaceous stream. The percentage weight fraction of sulfur in the transition metal sulfide provably increases. Proof can be furnished, for example, using elemental analysis by determining the percentage weight fraction of sulfur in the transition metal sulfide comprised in the absorbent at two different points in time and comparing the determined percentage fractions of sulfur with one another. This shows that the weight fraction of sulfur in the first elemental analysis of the transition metal sulfide (=first transition metal sulfide) is lower than in the second elemental analysis of the same transition metal sulfide carried out later after a longer period of use (=second transition metal sulfide). The increase in the percentage weight fraction of sulfur in the transition metal sulfide with advancing process duration is accompanied by an increase in the sulfur to transition metal amount of substance ratio (n_{S}/n_{M}).

Thus, in the process according to the invention at least some of the sulfur present in the sulfur compound or compounds becomes bound in the transition metal sulfide as additional sulfur. Owing to the binding of additional sulfur, the first transition metal sulfide forms a second transition metal sulfide which, in particular, differs from the first transition metal sulfide in that it has a higher percentage weight fraction of sulfur and a larger sulfur to transition metal amount of substance ratio.

Using qualitative gas chromatography, it is possible to detect in the output stream of the reaction vessel the compounds that at least some of the sulfur compounds are converted into during contacting with the transition metal sulfides. For example, at least some of the n-butyl mercaptan is converted to n-butane in the process according to the invention.

Without wishing to limit the present invention in any way, it is believed that generally in the process according to the invention at least some of the mercaptans (R—SH), organic sulfides (R—S—R′), organic disulfides (R—S—S—R′) and carbonyl sulfide (COS) undergo the below illustrated reactions with the first transition metal sulfide. (shown here in simplified form as the stoichiometric formula MₓS_{y}).

MₓS_{y}+R—S—H→MₓS_{y+1}+R—H

MₓS_{y}+R—S—R′→MₓS_{y+1}+R—R′

2MₓS_{y}+R—S—S—R′→2MₓS_{y}+R—R′

MₓS_{y}+O═C═S→MₓS_{y+1}+C≡O (carbon monoxide)

The sulfur-laden absorbent comprising a second transition metal sulfide can be regenerated by heating in a regeneration step once the absorption step has been completed. The second transition metal sulfide comprised in the absorbent is completely or partially converted back to the first transition metal sulfide, and elemental sulfur is released.

The elemental sulfur formed in the regeneration step consists essentially of molecules of S₂, S₃, S₄, S₅, S₆, S₇ and S₈, the relative abundance of which depends on the temperature and pressure in the regeneration step.

Thus, in one embodiment of the process according to the invention the second transition metal sulfide is regenerated by heating in a regeneration step, wherein the first transition metal sulfide and elemental sulfur are formed.

The present invention therefore also provides a process for removing sulfur compounds selected from mercaptans (R—SH), organic sulfides (R—S—R′) and carbonyl sulfide (COS) from a hydrocarbonaceous stream, which process comprises an absorption step of contacting the hydrocarbonaceous stream comprising one or more sulfur compounds with an absorbent comprising a first transition metal sulfide to bind at least some of the sulfur present in the sulfur compound or compounds in the transition metal sulfide as additional sulfur to form a second transition metal sulfide, and a regeneration step of regenerating the second transition metal sulfide by heating to form the first transition metal sulfide and elemental sulfur.

The second transition metal sulfide is preferably regenerated by heating to a temperature of from 500 to 1000° C.

The prevailing pressure in the regeneration step is generally variable over a wide range. All that matters is that elemental sulfur be released.

The regeneration step is preferably carried out at a pressure of no more than 10 bar, more preferably of no more than 5 bar, most preferably of no more than 2 bar, and at a pressure of at least 0.001 bar, more preferably of at least 0.005 bar, most preferably of at least 0.01 bar.

The Absorbent comprising a second transition metal sulfide is preferably regenerated in a hot inert gas stream. To this end, the hot inert gas stream is passed over the absorbent. The term “hot inert gas stream” is to be understood for the purposes of the present invention as meaning a gas stream comprising at least 75 vol % of a gas behaving inertly in the regeneration step.

This inert gas in particular does not undergo a chemical reaction with either the sulfur being formed or with the absorbent. Useful inert gases include, for example, nitrogen, methane, flue gas (carbon dioxide and water), carbon dioxide and noble gases such as argon. The inert gas stream preferably comprises at least 80 vol %, more preferably at least 90 vol % and most preferably at least 95 vol % of a gas that behaves inertly. The term “hot inert gas stream” is to be understood for the purposes of the present invention as meaning an inert gas stream that is heated prior to use in the regeneration step. The hot inert gas stream in the process according to the invention is generally at a temperature of between 200 and 1000° C., preferably between 300 and 800° C. and more preferably between 400 and 800° C.

The elemental sulfur is generally discharged with the hot inert gas stream. This inert gas stream comprising sulfur can then be easily cooled for example with a heat exchanger to change the physical state of the elemental sulfur, so that it can eventually be easily removed from the inert gas in liquid or solid form.

In order to increase the rate of regeneration, the absorbent to be regenerated and which comprises a second transition metal sulfide can additionally be heated. In a further embodiment of the invention, the absorbent is contacted with a hot inert gas stream and heated.

In a preferred embodiment of the present invention the process is carried out in at least two fixed-bed reactors, in which case the absorption step is carried out in one fixed-bed reactor and the regeneration step is carried out in a further fixed-bed reactor, on an alternating basis.

In a further preferred embodiment of the present invention the process is carried out in at least two fluidized-bed reactors, in which case the absorption step is carried out in a first fluidized-bed reactor and the regeneration step is carried out in a second fluidized-bed reactor, on a continuous basis.

Particularly preferred embodiments of the process according to the invention are illustrated in detail hereinafter using the figures briefly described below.

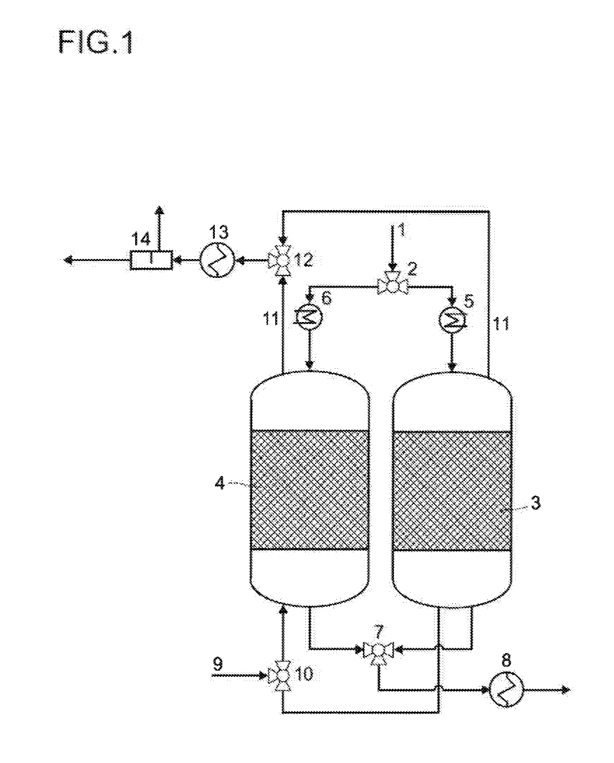

FIG. 1 shows a schematic flow diagram of a particularly preferred embodiment of the present invention wherein the desulfurization process is carried out in two fixed-bed reactors and wherein the absorption step is carried out in one fixed-bed reactor and the regeneration step is carried out in a further fixed-bed reactor, on an alternating basis.

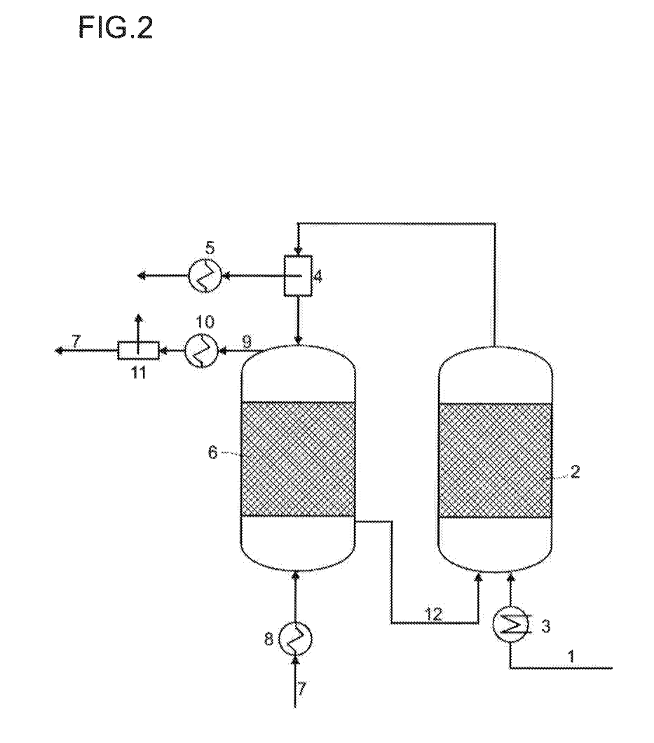

FIG. 2 shows a schematic flow diagram of a further particularly preferred embodiment wherein the desulfurization process is carried out in two fluidized-bed reactors and wherein the absorption step is carried out in a first fluidized-bed reactor and the regeneration step is carried out in a second fluidized-bed reactor, on a continuous basis.

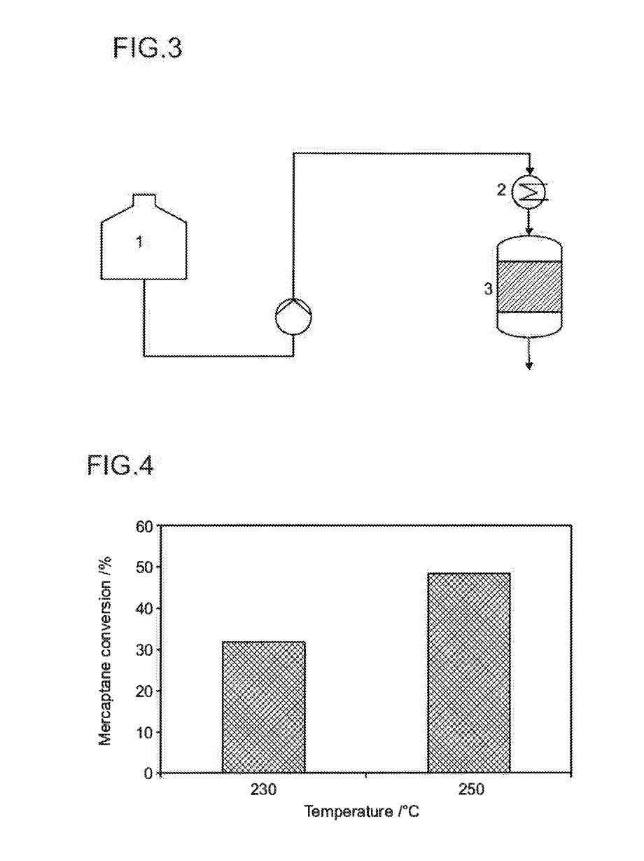

FIG. 3 shows a schematic flow diagram of an experimental setup with which the utility of the transition metal sulfide as absorbent was demonstrated. A reservoir 1 is shown, from which a hydrocarbonaceous stream contaminated with sulfur compounds exits and is passed to a vaporizing apparatus 2 where it vaporizes and is eventually introduced into a flow tube reactor 3 which contains a fixed bed of absorbent comprising transition metal sulfide.

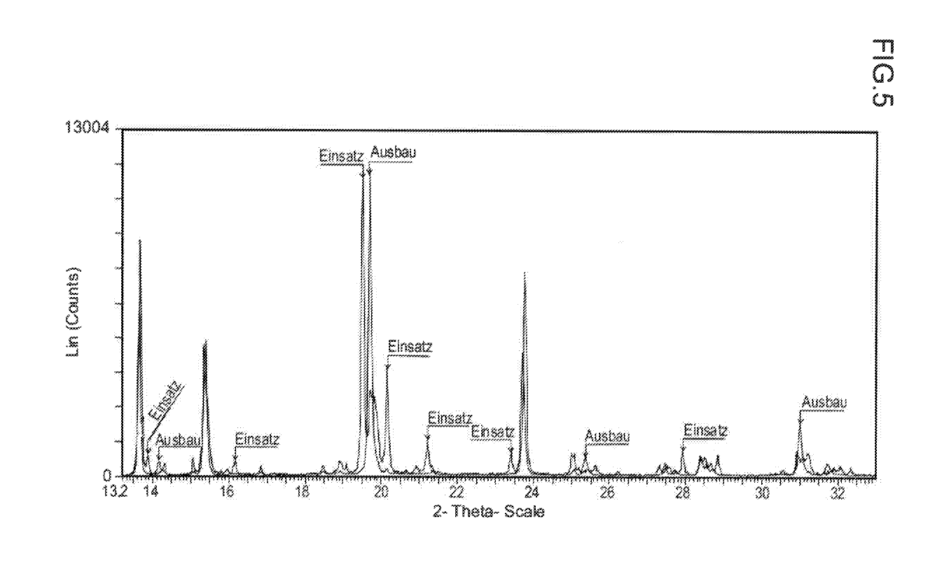

FIG. 4 shows a diagram indicating the mercaptan conversion achieved at different temperatures in a flow tube reactor which contains a fixed bed of absorbent comprising a first transition metal sulfide.

FIG. 5 shows the graphically superimposed X-ray diffraction patterns for fresh FeS used as absorbent and for used, sulfur-laden absorbent FeₓS_{y}.

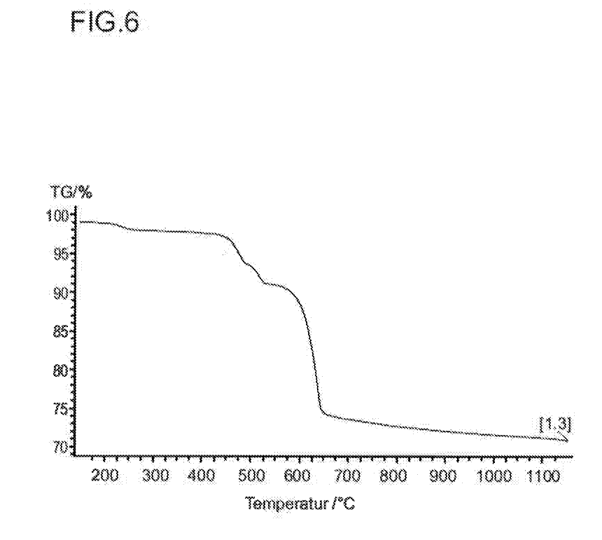

FIG. 6 shows the change in mass of pure pyrite (FeS₂) as a function of temperature.

In a particularly preferred embodiment of the process according to the invention, the desulfurization is carried out in two fixed-bed reactors (see FIG. 1) to carry out the absorption step in one of the two fixed-bed reactors at a time while the other fixed-bed reactor is regenerated, on an alternating basis,

A provided hydrocarbonaceous stream 1 comprises sulfur compounds such as mercaptans (R—SH), sulfides (R—S—R′), disulfides (R—S—S—R′), hydrogen sulfide (H₂S), carbonyl sulfide (COS) and/or thiophenes. Using a distributor 2, the hydrocarbonaceous stream 1 is passed to either a reaction vessel 3 or a reaction vessel 4, as desired. Each of the reaction vessels 3 and 4 can be operated as absorber and as regenerator on an alternating basis to ensure a continuous desulfurization process. Both reactors can, for example, be configured in the form of a fixed bed. When the absorption of the sulfur compounds is carried out in reactor 3, hydrocarbon-aqueous stream 1 is passed through reactor 3. A heating means 5 can be used to set the reaction temperature which is typically in the range from 200° C. to 400° C. The desulfurized hydrocarbonaceous stream is passed using a distributor 7 to a heat exchanger 8 for heat recovery and is discharged from the process.

The absorbent can be regenerated concurrently in reaction vessel 4. To this end, the regeneration gas, for example methane, flue gas (CO₂ and H₂O), nitrogen or a different inert gas (e.g. noble gases), is passed into the reaction vessel 4 using distributor 10. The regeneration of the absorbent is effected at high temperatures (>600° C.). The temperature can be raised either using a heating means 6 or using the heat content of regeneration gas 9. An offgas 11 composed of the regeneration gas 9 and desorbed sulfur exits the reactor. The offgas 11 is discharged from the process using a distributor 12 and cooled down in a heat exchanger 13 to condense out the sulfur, so that it can eventually be separated from the regeneration gas in a separation apparatus 14. The regeneration gas can subsequently be fed back into the process (9).

Using the process setup, the mode of operation i.e. absorption or regeneration, of the reaction vessels 3 and 4 can be established using the distributors 2, 7, 10 and 12.

In the further preferred embodiment of the process according to the invention, shown in FIG. 2, the desulfurization is achieved using two fluidized-bed reactors to carry out the absorption step in a first fluidized-bed reactor and the regeneration step in a second fluidized-bed reactor, on a continuous basis.

A hydrocarbonaceous stream 1 comprising sulfur compounds such as mercaptans (R—SH), disulfides (R—S—S—R′), hydrogen sulfide (H₂S), carbonyl sulfide (COS) and thiophenes is introduced together with an absorbent 12 into a reaction vessel 2 which is, for example, configured in the form of a solid conveying reactor. In an advantageous variant of the particularly preferred embodiment, the reaction vessel is configured as a fluidized-bed reactor (circulating fluidized bed). In a further variant of the particularly preferred embodiment, a solid conveying reactor design (e.g. screw reactor) is used. A heating means 3 can be used to set the reaction temperature which is typically between 200 and 400° C. The desulfurized hydrocarbon-aceous stream and also the absorbent that has absorbed the sulfur exit the reactor and are fed to a separation apparatus 4 in which separation of the sulfur-laden absorbent from the desulfurized hydrocarbonaceous stream is effected. Following heat recovery in a heat exchanger 5, the desulfurized hydrocarbonaceous stream is discharged from the process.

The sulfur-laden absorbent is regenerated in reaction vessel 6, which in an advantageous variant of the particularly preferred embodiment is configured as a solid conveying reactor. To this end, a regeneration gas 7, e.g. methane, flue gas (CO₂ and H₂O), nitrogen or a different inert gas (e.g. noble gases), is passed through the regenerator 6. The regeneration of the absorbent is effected at high temperatures (>600° C.). The temperature is raised using the heat content of the regeneration gas which may be heated up using a heat exchanger 8. An offgas 9 composed of regeneration gas and desorbed elemental sulfur exits the reactor at its top. The offgas 9 is cooled using a heat exchanger 10 to change the physical state of the elemental sulfur, so that it can eventually be removed from the regeneration gas 7 in liquid or solid form in a separating apparatus 11. The regeneration gas 7 can subsequently be fed back into the process. The regenerated absorbent 12 is eventually fed back to the reaction vessel 2.

The utility of the described absorbents for removing sulfur compounds from hydrocarbonaceous streams is shown in the following examples:

### EXAMPLES

### Example 1

### Absorption Step

The absorption step was carried out in a continuous tubular reactor, the construction of which is shown in FIG. 3. 50 g/h of a hydrocarbonaceous stream 1 consisting of 0.500 wt % of butanethiol in hexane were vaporized in a vaporizing apparatus 2 together with a gaseous stream of 10 l/h (S.T.P) of N₂ and passed through a flow tube reactor 3. This reactor was packed with a total of 50 g of FeS particles (mean particle diameter: 150 μm; purity 99.9%, verified by elemental analysis and X-ray structure analysis). In order to prevent agglomeration of the FeS particles, 37 g of Al₂O₃ spheres (mean diameter: 0.6 mm) were added to the fixed bed to dilute the particles. This resulted in a total fixed-bed volume of 70 ml.

The butanethiol (C₄H₉SH) conversion was determined at different temperatures at a pressure of 40 bar. FIG. 4 shows that the butanethiol conversion is about 32% at 230° C. and about 49% at 250° C. According to kinetic evaluation of these data, complete conversion i.e. a butanethiol conversion of 100% can be achieved at temperatures of 350° C. and above. Additionally, qualitative GC analysis of the gas phase did detect butane (C₄H₁₀) formation.

Shown in simplified form, the FeS particles undergo the following reaction with butanethiol:

FeS+C₄H₉SH→FeS₂+C₄H₁₀

After a reaction run time of 220 h, the fixed bed was removed and the Al₂O₃ was separated off in order to analyze the sulfur-laden iron sulfide FeSₓ used as absorbent both by X-ray diffraction and by elemental analysis.

FIG. 5 shows the X-ray diffraction patterns for fresh iron(II) sulfide FeS (black) and for the sulfur-laden iron sulfide FeₓS_{y} obtained after 220 h reaction run time (red). Comparing the two superimposed X-ray diffraction patterns shows that the sulfur-laden iron sulfide FeₓS_{y} has an Fe₇S₈ phase which the fresh iron(II) sulfide FeS does not have. Additional sulfur was thus incorporated into the FeS crystal lattice originally present, during the reaction.

Table 1 sets out the weight fractions of iron and sulfur for both the fresh iron(II) sulfide FeS and the sulfur-laden iron sulfide FeₓS_{y}, as determined using elemental analysis. It is clearly apparent that the sulfur/iron ratio increased during the reaction run time. The weight fractions of Fe and S determined for the sulfur-laden iron sulfide FeₓS_{y} likewise verify the existence of Fe₇S₈ phases.

TABLE 1

| Sample | Fe [wt %] | S [wt %] | C [wt %] |
|---|---|---|---|
| Fresh iron(II) sulfide FeS | 63 | 36.1 | — |
| Sulfur-laden iron sulfide FeₓS_{y} | 60 | 38.4 | — |

It is noted that the sulfur buildup in the FeS particles ensues in more than one step, as is shown below:

FeS→Fe₇S₈→Fe₃S₄→Fe₃S₂→FeS₂

The Fe and S contents of the sulfur-laden iron sulfide FeₓS_{y} that were determined using elemental analysis also show that the 220 h run time of the experiment was not sufficient to utilize the full capacity of the absorbent and ultimately arrive at pure FeS₂.

The transition metal sulfide Fe(II)S is therefore suitable for use as an absorbent for removing sulfur compounds from hydrocarbonaceous streams.

### Example 2

### Desorption Step

The sulfur-laden absorbent FeₓS_{y} which in accordance with example 1 was removed from the fixed bed after a reaction run time of 220 h was exposed to a regeneration stream consisting of nitrogen, for 30 min at 700° C. This simultaneously releases elemental sulfur and regenerates the sulfur-laden absorbent FeₓS_{y}. Shown in simplified form for a pure Fe₇S₈ phase, the following reaction proceeds:

2Fe₇S₃→FeS+S₂

As can be seen from table 2, this (regeneration) treatment reduced the sulfur/iron ratio, so that a ratio approaching that exhibited by the fresh iron(II) sulfide FeS was achieved.

TABLE 2

| Sample | Fe [wt %] | S [wt %] | C [wt %] |
|---|---|---|---|
| Sulfur-laden iron sulfide FeₓS_{y} | 60 | 38.4 | — |
| Regenerated iron sulfide FeₓS_{y} | 62 | 38.6 | — |

The transition metal sulfide Fe(II)S can thus be regenerated following use as an absorbent for removing sulfur compounds from hydrocarbonaceous streams.

### Example 3

### Desorption Step when Using Pure Pyrite (FeS₂)

Experiments with pure pyrite (FeS₂) were additionally carried out. Pyrite is crystalline and has the largest sulfur/iron ratio. The regeneration, i.e. desorption, step in which the reaction shown below in simplified form proceeds

2FeS₂→2FeS+S₂,

was carried out in a TG/DSC test apparatus. In each case 35 mg of FeS₂ (sulfur/iron ratio verified by elemental and X-ray structure analysis) were heated to a temperature of 1100° C. at a constant heating rate together with the regeneration gas argon (flow: 20 ml/min). The heating rates were in the range from 1 K/min to 30 K/min. The change in mass as a function of temperature, and accordingly time, was recorded. Any bound water was removed by 30 minutes of baking-out at 150° C. under an inert gas stream.

FIG. 6 shows the change in mass as a function of temperature. The fact that the change in mass ceases at 27% and that consequently the remaining solid has a mass of about 73% based on the mass of the pyrite (FeS₂) used is unsurprising and corresponds exactly to the ratio of the molar masses of FeS to FeS₂ (see FIG. 6). It therefore clearly follows that even if the absorbent FeS were fully laden with sulfur, so that a sulfur-laden absorbent of the stoichiometric ratio FeS₂ were present, desorption of sulfur can be effected and regeneration of FeS can take place. Further details can also be taken from the literature specified below: L. Charpentier, P. Masset, “Thermal Decomposition of Pyrite FeS₂ under Reducing Conditions”, Materials Science Forum, 654-656 (2010) 2398.

1.-11. (canceled)

12. A process for removing sulfur compounds selected from the group consisting of mercaptans, organic sulfides, organic disulfides and carbonyl sulfide, from a hydrocarbonaceous stream, the process comprising:
an absorption step comprising contacting the hydrocarbonaceous stream comprising one or more sulfur compounds with an absorbent comprising a first transition metal sulfide comprising iron (II) sulfide having the stoichiometric formula FeS_{0.5-1.6} to bind at least some of the sulfur present in the sulfur compound or compounds in the transition metal sulfide as additional sulfur to form a second transition metal sulfide, and wherein the second transition metal is regenerated by heating in a regeneration step, wherein the first transition metal sulfide and elemental sulfur are formed.

13. The process according to claim 12, wherein the first and the second transition metal sulfide are present in a fixed bed.

14. The process according to claim 12, wherein the first and the second transition metal sulfide are present in a fluidized bed.

15. The process according to claim 12, wherein the hydrocarbonaceous stream is contacted with the first transition metal sulfide at a temperature of from 200 to 400° C.

16. The process according to claim 15, wherein the second transition metal sulfide is regenerated by heating to a temperature of from 500 to 1000° C.

17. The process according to claim 16, wherein the second transition metal sulfide is regenerated in a hot inert gas stream.

18. The process according to claim 14, wherein the process is carried out in at least two fixed-bed reactors, wherein the absorption step is carried out in one fixed-bed reactor and the regeneration step is carried out in a further fixed-bed reactor, on an alternating basis.

19. The process according to claim 12, wherein the process is carried out in at least two fluidized-bed reactors, wherein the absorption step is carried out in a first fluidized-bed reactor and the regeneration step is carried out in a second fluidized-bed reactor, on a continuous basis.

20. The process according to claim 12, wherein the hydrocarbonaceous stream comprises C₁-C₆ mercaptans.

21. The process according to claim 12, wherein the content of mercaptans in the hydrocarbonaceous stream prior to carrying out the absorption step is 0.001 to 5 vol %.

22. The process according to claim 12, wherein the hydrocarbonaceous stream comprises at least 80 vol % of C₁-C₆ alkanes.
